(19) United States
(12) Patent Application Publication
(10) Pub. No.: US 2008/0187758 A1
(43) Pub. Date: Aug. 7, 2008

(54) METHOD FOR FORMING GRAFT POLYMERIZATION LAYER, ELECTRONIC DEVICE, AND ELECTRONIC APPARATUS

(75) Inventors: Shinobu YOKOKAWA, Fujimi-machi (JP); Hitoshi FUKUSHIMA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/026,265

(22) Filed: Feb. 5, 2008

(30) Foreign Application Priority Data
Feb. 6, 2007 (JP) 2007-027360

(51) Int. Cl. B32B 9/00; B05D 3/00

(52) U.S. Cl. 428/411.1; 427/393.5

(57) ABSTRACT

A method for forming a graft polymerization layer comprises: (a) forming a polymerization initiation layer on a base material by linking the base material with a linking group of a polymerization initiator that contains the linking group and a chemical bond activated by a polymerization catalyst; and (b) separately supplying to at least a partial region on the polymerization initiation layer a first solution containing the polymerization catalyst and a second solution containing a first monomer having a group polymerizable to the chemical bond and a first side chain by use of a droplet discharge method so as to form the graft polymerization layer constituted of a first graft polymer containing more than one first monomer linearly linked to the chemical bond.

The entire disclosure of Japanese Patent Application No. 2007-027360, filed Feb. 6, 2007 is expressly incorporated by reference herein.

### BACKGROUND

1. Technical Field

The present invention relates to a method for forming a graft polymerization layer, an electronic device, and an electronic apparatus.

2. Related Art

Thin film formation using polymers is generally conducted by supplying a polymer-containing solution to the surface of a base material using a liquid-phase film formation method such as casting, spin casting, or spraying and, after forming a liquid thin film composed of this solution, drying this liquid thin film.

However, it is known that this method allows formation of only thin films containing low-density polymers.

In contrast, in recent years, numerous researches are being conducted on a graft polymerization layer (polymer brush) having a polymer that is produced by linking a polymerization initiator having polymerization starting points to the surface of a base material and by sequentially linking the polymerization starting points of the polymerization initiator to monomers (e.g., JP-A-2004-161995). According to such a method for forming a graft polymerization layer, it is possible to increase density of the polymer contained in the resultant layer and, by selecting a reaction system when linking the monomers, to produce the polymer under simple and mild conditions.

An example of such a method is a method in which a graft polymerization layer is produced by forming, on a base material, a polymerization initiation layer composed of a polymerization initiator having polymerization starting points activated by a polymerization catalyst and then supplying a solution containing the polymerization catalyst and monomers linkable to the polymerization starting points. However, in such a method, the monomers may sometimes react to each other before the solution is supplied onto the polymerization initiation layer because the polymerization catalyst and the monomers are contained in a single solution. Accordingly, there are problems that the supply of the solution onto the polymerization initiation layer becomes difficult due to the raised viscosity of the solution, and that the resultant graft polymerization layer contains the polymer having an uneven density because of generation of oligomers that do not link to the polymerization initiation layer.

### SUMMARY

An advantage of the invention is to provide a method for forming a graft polymerization layer that allows formation of a graft polymerization layer having a uniform polymer density, and an electronic device containing the graft polymerization layer formed by such a method, and a highly reliable electronic apparatus.

According to a first aspect of the invention, a method for forming a graft polymerization layer includes: (a) forming a polymerization initiation layer on a base material by linking the base material with a linking group of a polymerization initiator that contains the linking group and a chemical bond activated by a polymerization catalyst; and (b) separately supplying to at least a partial region on the polymerization initiation layer a first solution containing the polymerization catalyst and a second solution containing a first monomer having a group polymerizable to the chemical bond and a first side chain by use of a droplet discharge method so as to form the graft polymerization layer constituted of a first graft polymer containing more than one first monomer linearly linked to the chemical bond.

In this case, the polymerization catalyst is reacted with the first monomer at a point when the first solution has been mixed with the second solution on the polymerization initiation layer. Thus, the viscosities of these solutions may be reliably prevented from increasing before the solutions are supplied to the base substrate, and generation of oligomers that do not link to the polymerization initiation layer may be suitably suppressed or prevented. As a result, a graft polymerization layer having a uniform polymer density may be formed.

According to a second aspect of the invention, a method for forming a graft polymerization layer includes: (a) forming a polymerization initiation layer on a base material by linking the base material with a linking group of a polymerization initiator that contains the linking group and a chemical bond activated by a polymerization catalyst, and forming a stabilizing layer containing a stabilizing agent having no chemical bond activated by the polymerization catalyst but having the linking group that links the stabilizing agent to the base material in a region on the base material outside the region for forming the polymerization initiation layer; and (b) separately supplying to at least a partial region on the polymerization initiation layer a first solution containing the polymerization catalyst and a second solution containing a first monomer having a group polymerizable to the chemical bond and a first side chain by use of a droplet discharge method so as to form the graft polymerization layer constituted of a first graft polymer containing more than one first monomer linearly linked to the chemical bond.

In this case, the polymerization catalyst is reacted with the first monomer at a point when the first solution has been mixed with the second solution on the polymerization initiation layer. Thus, the viscosities of these solutions may be reliably prevented from increasing before the solutions are supplied to the base substrate, and generation of oligomers that do not link to the polymerization initiation layer may be suitably suppressed or prevented. As a result, a graft polymerization layer having a uniform polymer density may be formed.

It is preferable that, in step (a), the polymerization initiation layer be formed corresponding to a site at which the graft polymerization layer is to be formed.

In this case, even if the first and second solutions are supplied to a region not having the polymerization initiation layer in step (b), it is possible to reliably prevent formation of the graft polymerization layer in this region because of lack of the polymerization initiation layer in this region. In other words, it is possible to improve precision in forming the graft polymerization layer corresponding to the site at which the graft polymerization layer is to be formed.

It is preferable that, in step (b), the second solution be supplied onto the polymerization initiation layer after supplying the first solution.

In this case, the first monomer is supplied after the chemical bond, which is exposed at the surface of the polymerization initiation layer, has been activated by the polymerization catalyst contained in the first solution. As a result, chances of the chemical bond to remain inactivated may be suitably prevented or reduced, and thus a graft polymerization layer having a uniform film density may be formed.

It is preferable that, in step (b), the first solution be supplied onto the polymerization initiation layer after supplying the second solution.

In this case, there is a tendency that, between the first and second solutions, the viscosity of the second solution containing the first monomers is the higher in general. Therefore, by supplying the second solution having the higher viscosity than the first solution onto the polymerization initiation layer before supplying the first solution, it becomes possible to reliably prevent spreading of the first solution supplied by the droplet discharge method from the region on the polymerization initiation layer to which the first solution has been supplied. As a result, the graft polymerization layer may be reliably formed within this region.

It is preferable that at least a same kind of solvent be used in the first and second solutions.

In this case, the first and second solutions may be completely dissolved without experiencing separation. That is, the first and second solutions may be unfailingly mixed. As a result, each part of the formed graft polymerization layer may have a uniform film density.

It is preferable that the solvent be ionic liquid.

In this case, since the ionic liquid is a nonvolatile solvent, it may suitably prevent evaporation of the solvent itself when the first monomer is polymerized through the graft polymerization. Accordingly, it is possible to reliably prevent the polymerization of the first monomer from stopping in the middle of the course.

It is preferable that the method for forming a graft polymerization layer further include: (c) supplying to the layer formation region a third solution containing a second monomer having the group polymerizable to the first monomer and a second side chain different from the first side chain so as to link a second graft polymer containing more than one second monomer linearly linked to the first graft polymer.

In this case, it is possible to provide a graft polymerization layer containing a graft polymer having a complex structure in that the second graft polymer is linked to the first graft polymer.

It is preferable that the method for forming a graft polymerization layer further include washing the first and second solutions prior to step (c).

In this case, it is possible to provide the graft polymerization layer containing a graft polymer which includes the first graft polymer composed of a polymer of the first monomers that is linked to the second graft polymer composed of a polymer of the second monomers.

It is preferable that the method for forming a graft polymerization layer further include introducing a substituent group to the first side chain after step (b).

In this case, the graft polymerization layer may attain the characteristics of the substituent group.

It is preferable that the method for forming a graft polymerization layer further include introducing a modifying group to a terminal of the first graft polymer after step (b).

In this case, the graft polymerization layer may attain the characteristics of the modifying group.

According to a third aspect of the invention, an electronic device contains the graft polymerization layer formed by the method for forming a graft polymerization layer according to the first and second aspects of the invention.

In this case, a highly reliable electronic device may be obtained.

According to a fourth aspect of the invention, an electronic apparatus contains the electronic device according to the third aspect of the invention.

In this case, a highly reliable electronic apparatus may be obtained.

### BRIEF DESCRIPTION OF THE DRAWINGS

The invention will be described with reference to the accompanying drawings, wherein like numbers reference like elements.

FIGS. 1A through 1D are schematic diagrams to explain a first method for forming a graft polymerization layer.

FIG. 2 is a pattern diagram to explain each process of the method for forming a graft polymerization layer shown in FIGS. 1A through 1D.

FIG. 3 is a pattern diagram to explain each process of the method for forming a graft polymerization layer shown in FIGS. 1A through 1D.

FIG. 4A through 4C are schematic diagrams to explain a third method for forming a graft polymerization layer.

FIG. 5 is a pattern diagram to explain each process of the method for forming a graft polymerization layer shown in FIG. 4A through 4C.

FIGS. 6A and 6B are schematic diagrams to explain a fourth method for forming a graft polymerization layer.

FIG. 7 is a pattern diagram to explain each process of the method for forming a graft polymerization layer shown in FIGS. 6A and 6B.

FIG. 8A is a vertical sectional diagram showing an organic thin film transistor having a top gate structure.

FIG. 8B is a plan diagram of the organic thin film transistor of FIG. 8A.

FIG. 9 is a diagram (vertical sectional diagram) showing an organic thin film transistor having a bottom gate structure.

FIG. 10 is a perspective diagram showing the composition of a mobile-type (or notebook-type) personal computer containing an electronic apparatus of the invention.

FIG. 11 is a perspective diagram showing the composition of a mobile phone (including PHS: personal handyphone system) using the electronic apparatus of the invention.

### DESCRIPTION OF EXEMPLARY EMBODIMENTS

Embodiments of the invention will now be described.

The method for forming a graft polymerization layer according to the embodiments of the invention will be described first.

Method for Forming Graft Polymerization Layer

First Formation Method

The first method for forming the graft polymerization layer will now be described.

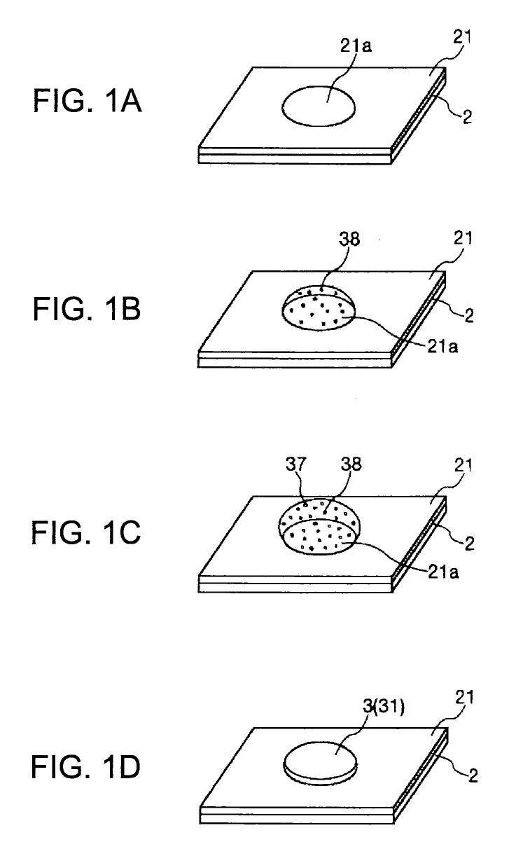

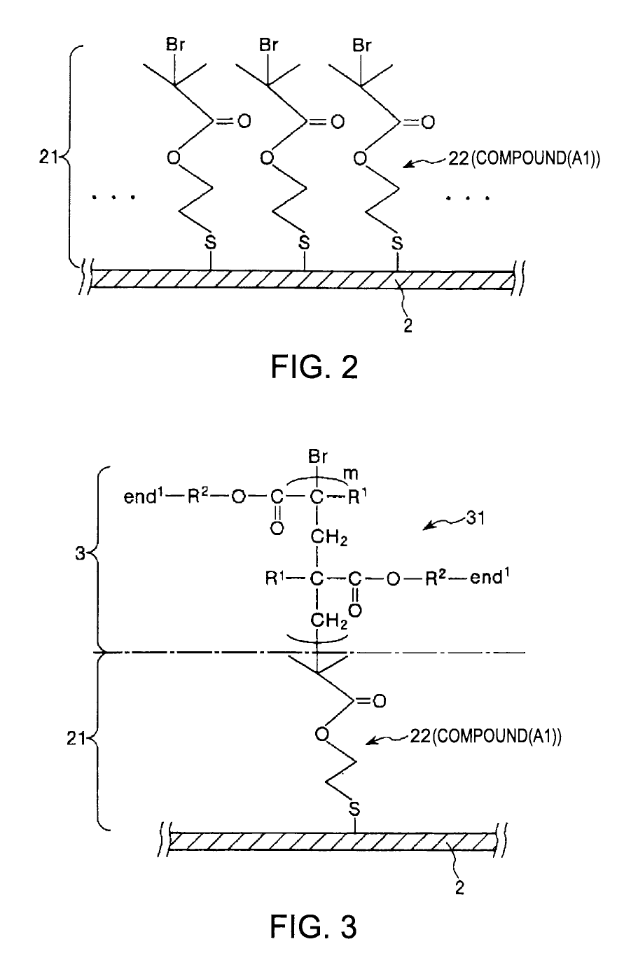

FIGS. 1A through 1D are schematic diagrams to explain the first method for forming a graft polymerization layer. FIGS. 2 and 3 are pattern diagrams to explain each process of the method for forming a graft polymerization layer shown in FIGS. 1A through 1D. In the following descriptions, “up” is used to mean the top side and “down or under” to mean the bottom side in FIGS. 1A through 1D, FIG. 2, and FIG. 3.

The first method for forming the graft polymerization layer includes: a process for forming a polymerization initiation layer in which a polymerization initiation layer 21 is formed on a base material 2 (FIG. 1A), a process for supplying a first solution in which a first solution containing a polymerization catalyst 38 is supplied onto the polymerization initiation layer 21 (FIG. 1B), and a process for supplying a second solution in which a second solution containing a first monomer 37 is supplied (FIG. 1C). Formed on the polymerization initiation layer 21 as a result is a graft polymerization layer 3 composed of a first graft polymer having the first monomer 37 that is linearly linked to the polymerization initiation layer 21 due to the catalytic action of the polymerization catalyst 38 (FIG. 1D).

Referring to FIGS. 1A to 1D, in the method for forming the graft polymerization layer according to the embodiments of the invention, the first and second solutions are separately and selectively supplied by a droplet discharge method (inkjet method) so as to correspond to a layer formation region 21a that is a site on the polymerization initiation layer 21 at which the graft polymerization layer 3 is to be formed. The droplet discharge method enables the selective supply of the first and second solutions to a desired position, i.e., the layer formation region 21a on the polymerization initiation layer 21, without requiring large-scale equipment such as a vacuum unit, a mask pattern, and the like. Further, by the droplet discharge method, the first and second solutions are selectively supplied to the layer formation region 21a on the polymerization initiation layer 21. Therefore, less material is wasted compared to a case that involves removal of the graft polymerization layer formed over the upper surface of the polymerization initiation layer 21 in a region outside the film formation region 21a. Also, since the material used in the method for forming the graft polymerization layer according to the embodiments of the invention is particularly expensive, it is possible to largely cut costs by selectively supplying the material to the region for forming the film.

Each of the above-mentioned processes will now be described in detail.

1A: Process for Forming Polymerization Initiation Layer (First Process)

Prepared first as a polymerization initiator 22 is a chemical compound A1 shown below having, at one end, a chemical bond activated by the polymerization catalyst 38 which will be mentioned hereafter and, at the other end, a SH group acting as a linking group.

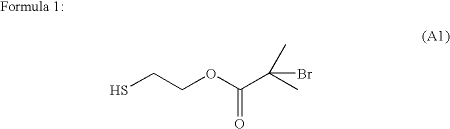

Also prepared is the base material 2 having a surface containing a metal layer composed of a metal material such as Au, Ag, Cu, or an alloy of these metals. The entire base material 2 may be composed of the metal layer, or the surface may be composed of the metal layer.

Then, with reference to FIG. 2, the polymerization initiator 22 is bonded (linked) to the surface of the base material 2 by —S— bond by reacting the SH group of the polymerization initiator 22 with the surface of the base material 2, thereby forming the polymerization initiation layer 21.

This bond is possible, for example, by bringing a solution containing the polymerization initiator 22 as expressed by the chemical compound A1 to come in contact with the surface of the base material 2.

A solvent used to dissolve the polymerization initiator 22 may be, but not limited to, such that dissolves the polymerization catalyst 38 which will be explained hereafter.

Through the process above, the polymerization initiator 22 is fixed (linked) to the surface of the base material 2.

In addition to the compound A1, a compound A2 shown below having, for example, a Si—X group as a linking group can be used as the polymerization initiator 22.

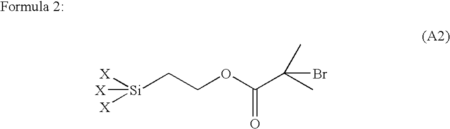

(where X represents a hydrolyzable group that produces a silanol group by hydrolysis.)

Used in this case as the base material 2 is a base material having the surface containing: an inorganic oxide layer composed of an inorganic oxide material such as SiO₂, TiO₂, or Al₂O₃, or an organic layer composed of, e.g., a polyethylene terephthalate (PET) organic material whose surface is treated by chemical etching, ultraviolet irradiation, or ozone treatment. Because a hydroxyl group is exposed at the surface of the base material 2, the polymerization initiator 22 is bonded (linked) to the surface by —Si—O— bond.

In addition to a —Br group contained in the compounds A1 and A2, another example of the chemical bond contained in one terminal of the polymerization initiator 22 may be a sulphonyl chloride (—SO₂Cl) group.

2A: Process for Supplying First Solution

Prepared next is the first solution containing the polymerization catalyst 38. The first solution can be fixed, for example, by dissolving the polymerization catalyst 38 in a solvent.

The polymerization catalyst 38 may be any catalyst that can activate a growing terminal when the polymer grows in the process for supplying the second solution, which will be described hereafter. Examples of the catalyst include: a halide, hydroxide, oxide, alkoxide, cyanide, cyanade, thiocyanate, and an azide of a transition metal, and a transition metal complex of which transition metal has a common ligand such as bipyridyl, phosphine, or a carbon monoxide. Among these, a catalyst constituted mainly of a halide of a transition metal is preferable. The reason that the polymerization catalyst 38 constituted mainly of a halide of a transition metal is preferable is that it is suited for living polymerization. Also, it is preferable since it is relatively inexpensive, readily available, and easy to handle.

Examples of the transition metal are Cu, Fe, Au, Ag, Hg, Pd, Pt, Co, Mn, Ru, Mo, Nb, and Zn.

Preferred examples of the solvent for dissolving the polymerization catalyst 38 are, but not limited to: water; alcohols such as methanol, ethanol, and butanol; halogenated aromatic hydrocarbons such as o-dichlorobenzene; and ethers such as diethylether and tetrahydrofuran. In particular, it is preferable to use ionic liquid (room temperature molten salt) such as: aliphatic quaternary ammonium ionic liquid such as N,N-diethyl-N-methyl-(2-methoxylethyl) ammonium tetrafluoroborate or N,N-diethyl-N-methyl-(2-methoxylethyl) ammonium bis(trifluoromethanesulfonyl)imide; imidazolium inonic liquid such as 1-ethyl-3-arylimidazolium iodine or 1-sec-buthyl-3-arylimidazolium tetrafluoroborate; or pyridinium ioninc liquid such as 4-(2-octyloxynaphthalene-6-yl)pyridinium iodine or 4-(2-octyloxynaphthalene-6-yl)pyridinium tetrafluoroborate. Because of its nonvolatile and noncombustibile characteristics, the ionic liquid is a particularly safe organic material. These solvents can be used singly or as mixed.

The first solution is next supplied using the droplet discharge method (inkjet method) to the layer formation region 21a corresponding to the site on the polymerization initiation layer 21 at which the graft polymerization layer 3 is to be formed, so that a first liquid film containing the polymerization catalyst 38 is formed.

3A: Process for Supplying Second Solution

Prepared next is the second solution containing a polymerizable group polymerizable to a chemical bond and the first monomer 37 having a first side chain. The second solution can be fixed, for example, by dissolving the first monomer 37 in a solvent.

A polymer group contained in the first monomer 37 may be such that includes a carbon-carbon double bond such as a vinyl group, styryl group, (meta)acryloyl group, vinylpyridyl group, or acrylamide group or that generates a ring-opening reaction such as a norbornyl group, epoxy group, or oxetanil group. It is preferable to use a monomer containing the styryl group or the (meta)acryloyl group because of its relatively high polymerization activity and inexpensiveness.

Examples of such a first monomer 37 are compounds represented by the following formulae B, C.

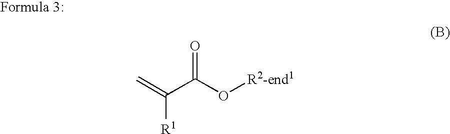

(where end¹ represents a terminal group of the first side chain; R¹ represents an hydrogen atom, methyl group, or an ethyl group; and R² represents a single bond, a methylene group, or an ethylene group.)

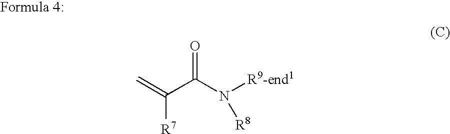

(where end¹ represents a terminal group of the first side chain; R⁷, R⁸ represent an hydrogen atom, methyl group, or an ethyl group; and R⁹ represents a single bond, a methylene group, or ethylene group.)

Examples of the terminal group (end¹) of the first chain are: a carboxyl group, hydroxyl group, epoxy group, (meta)acryloyl group, thiol group, isocyanato group, hydrogen atom, and a methyl group. Other than these functional groups, a functional site (e.g., a substituent group as will be described hereafter) may be initially introduced to the side chain terminal (end group) if there will be no influence from radical polymerization which will be described hereafter.

A solvent to dissolve the first monomer 37 may be, but not limited to, the same solvent as that explained to dissolve the polymerization catalyst 38.

In the embodiments of the invention, because the first and second solutions are prepared (fixed) separately, the second solution does not include the polymerization catalyst 38. Therefore, activation of the polymer group caused by the coexistence of the first monomer and the polymerization catalyst 38 is prevented. As a result, it is possible to reliably prevent the first monomers from linking to each other in the second solution, that is, to prevent formation of dimers, oligomers, polymers, and the like. Therefore, an increase in viscosity of the second solution is reliably prevented.

Next formed is a second liquid film containing the polymerization catalyst 38 and the first monomer 37. The second liquid film is formed by mixing the first solution with the second solution by supplying the second solution using the droplet discharge method (inkjet method) to the layer formation region 21a on the polymerization initiation layer 21, that is, by supplying the second solution to the first liquid film that was formed in the foregoing process 2A.

As described, when the second liquid film containing the polymerization catalyst 38 and the first monomer 37 is formed on the polymerization initiation layer 21 in a state that the chemical bond (C—Br bond in FIG. 2) is exposed at the surface of the polymerization initiation layer 21, the first monomer 37 is polymerized through living polymerization (atom transfer radical polymerization: ATRP) using the chemical bond of the polymerization initiator 22 (compound expressed by the formula A1) as a base point, and a first graft polymer 31 is thereby synthesized.

More specifically, when the first monomer 37 is reacted in the presence of the polymerization initiator 22 and the polymerization catalyst 38 in the second liquid film formed in the layer formation region 21a, the chemical bond contained in the polymerization initiator 22 is activated by the polymerization catalyst 38. As a consequence, the activated chemical bond and the first monomer 37 are united, and the atoms contained in the chemical bond activated by the polymerization catalyst of the polymerization initiator 22 move toward the first monomer 37. The chemical bond activated by the polymerization catalyst is thereby regenerated as the growing terminal. In this state, a main chain elongates along with regeneration of the growing terminal polymerized with the first monomer 37. As a result, the first graft polymer 31 having a plurality of first monomers linked linearly to the chemical bond is synthesized, and the graft polymerization layer 3 composed of the first graft polymer 31 is thereby produced.

For example, if the compound expressed by the formula B is used as the first monomer 37, and if CuBr is used as the polymerization catalyst, the first graft polymer 31 having the growing terminal shown in FIG. 3 is formed. Note that FIG. 3 shows a case in which the first graft polymer 31 is linked to one polymerization initiator 22 that is linked to the base material 2. In reality, however, a plurality of polymerization initiators 22 are linked to the base material 2, and the first graft polymer 31 is linked to each of the polymerization initiators 22.

As described above, the second solution can be brought into a state in which virtually no dimers, oligomers, polymers, or the like exist. Thus, because it is possible to reliably prevent the increase in the viscosity of the second solution, the second solution can be supplied reliably into the first liquid film formed in the layer formation region 21a by the droplet discharge method. Moreover, because incorporation of dimers, oligomers, polymers, or the like that do not link to the polymerization initiators 22 is suitably prevented or repressed, it is possible to form the graft polymerization layer 3 having a uniform polymer density in the layer formation region 21a on the base material 2 with the polymerization initiation layer 21 interposed therebetween.

Preferably, the first and second solutions (reaction solutions) are subjected to deoxidization before being supplied to the layer formation region 21a on the polymerization initiation layer 21. The de-oxidation process is performed by, for example, substitution by an inert gas such as argon gas or nitrogen gas after vacuum exhaust, or by a purging process.

The solvent contained in the first solution may be different from the solvent contained in the second solution, but they are preferably identical or of the same kind. If they are identical or of the same kind, the second solution does not separate in the first film when supplied to the first film composed of the first solution and, thus, is unfailingly dissolved in the second film. That is, the first and second solutions are dissolved without fail. As a result, the first monomer 37 and the polymerization catalyst 38 are uniformly dispersed in the second film, and the film density in each part of the produced graft polymerization layer 3 becomes uniform.

In this case, the same solvent or the solvent of the same kind is preferably the inonic liquid. As described hereinbefore, since the ionic liquid is a nonvolatile solvent, it suitably prevents evaporation of the solvent itself and drying of the second liquid film when the first monomer 37 is polymerized through graft polymerization. Accordingly, it is possible to reliably prevent stopping of the polymerization of the first monomer 37 in the middle of the course.

Additionally, the polymerization reaction among the first monomers 37 is promptly and reliably conducted by heating (raising the temperature of the second liquid film up to a predetermined temperature (a temperature at which the first monomers 37 and the polymerization catalyst are activated).

The heating temperature varies slightly depending on, e.g., the kinds of the first monomer 37 and the polymerization catalyst but ranges preferably, but not limited to, from about 20 to 50° C. If the heating temperature is in this range, the heating time (reaction time) is preferably about one to two hours. In contrast, if the film uniformity and thickness are to be precisely controlled, it is preferable that the reaction temperature be from about −10 to 10° C. even though the polymerization reaction slightly slows down.

In this first formation method, the first solution is supplied first and the second solution is supplied thereafter onto the polymerization initiation layer 21. Thus, the first monomer 37 is supplied after the chemical bond exposed at the surface of the polymerization initiation layer 21 has been activated by the polymerization catalyst 38 contained in the first solution. As a result, chances of the chemical bond to remain inactivated are suitably prevented or reduced and, thereby, the graft polymerization layer 3 having a uniform film density is formed.

Note that the first formation method includes a second step composed of the first solution supply process 2A and the second solution supply process 3A.

After this second step, a modifying group may be introduced to a terminal of the graft polymer 31. Accordingly, the graft polymerization layer 3 attains the characteristics (functions) of the modifying group.

Examples of the modifying group are, but not limited to, a luminous material, light-absorbing material, conductive material, enzyme, antigen, antibody, DNA, and a polymerization initiator. These kinds may be used singly, or more than one of these kinds may be used in combination.

Introduction of such a modifying group can be performed by reacting the above-mentioned chemical bond with this modifying group and the compound having a functional group reactive to the chemical bond that exists as the growing terminal at the terminal of the first graft polymer 31. As a result, the graft polymerization layer 3 attains the characteristics (functions) of the modifying group.

4A: Process for Supplying Polymerization Terminating Solution

A polymerization terminating solution containing the polymerization terminator is supplied by the droplet discharge method to the second liquid film remained on the graft polymerization layer 3 that has been formed in the layer formation region 21a. The first monomers 37 are thereby stopped from polymerization with the first graft polymer 31.

Examples of the polymerization terminator are, but not limited to: benzyl chloride, benzyl bromide, benzyl iodide, methyl chloride, methyl bromide, methyl iodide, ethyl chloride, ethyl bromide, ethyl iodide, butyl chloride, butyl bromide, butyl iodide, acetone, methyl isobutyl ketone, and diphenyl ketone. These kinds may be used singly, or more than one of these kinds may be used in combination. Additionally, as will be described in the third formation method, if a polymer layer is formed from another monomers (second monomers 39) following the termination of the polymerization reaction with the first monomers 37, an agent to temporally terminate the polymerization (temporal polymerization terminator) is used to maintain the activities of radical species of the reaction terminals. While it depends on the kind of the polymerization initiation layer, this temporal polymerization terminator may be, for example, a solution of cupric bromide and bipyridine if the polymerization initiation layer is based on alkyl halide.

Additionally, the solvent to be used when fixing the polymerization terminating solution is, but not limited to, the same solvent as that explained to dissolve the polymerization catalyst 38, for example.

The present process may be omitted if necessary.

Specifically, this process is omitted if most of the first monomers 37 contained in the second liquid film are reacted, for example.

Further, after this process, a substituent group may be introduced to the first side chain contained in the graft polymer 31.

Examples of the substituent group are, but not limited to, an organic metal complex such as ferrocene, macrocyclic ether such as crown ether, an arylamine derivative having a carrier transporting property, an antibody, and a nucleic acid. These kinds may be used singly, or more than one of these kinds may be used in combination.

If a carboxyl group, hydroxyl group, epoxy group, (meta)acryloyl group, thiol group, or an isocyanato group having a very reactive functional group is introduced as the terminal group (end¹) of the first chain, the above substituent group can be introduced by reacting the terminal group of the first side chain with the substituent group mentioned above and the compound having a functional group reactive to the terminal group of the first side chain.

Example of the functional group contained in this compound are: an amino group or the like if the terminal group of the first side chain is the carboxyl group, and a carbonyl chloride group if the terminal group of the first side chain is the hydroxyl group.

Specifically, if ferrocene is introduced as the substituent group provided that the terminal group of the first side chain is the hydroxyl group, the introduction can be conducted as follows as an example.

First, a compound expressed by the following chemical formula F having ferrocene is prepared.

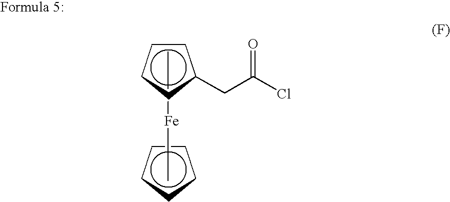

The compound expressed by this formula F can be obtained as shown below as an example.

First, ferrocene is dissolved in dichloromethane (DCM), and Na₂Fe(CO)₄ is added thereto and mixed together. Oxygen gas is then supplied, and a carboxyl group is introduced to ferrocene.

Then, this solution is brought into reaction with oxalyl chloride in DCM to convert the carboxyl group to a carbonyl chloride group, and the compound as expressed by the above formula F is thereby obtained.

Thereafter, the dichloromethane solution containing the compound expressed by the above formula F is supplied using the droplet discharge method onto the graft polymerization layer 3 composed of the first graft polymer 31. Consequently, the hydroxyl group contained in the first side chain is reacted with the carbonyl chloride group contained in the compound expressed by the formula F. An ester bond is thereby formed, and ferrocene is introduced to the first chain as a result.

Using such a method, the graft polymer 31 that is the graft polymerization layer 3 attains the characteristics (functions) of the substituent group.

5A: Washing Process

The second liquid film remained on the graft polymerization layer 3 is now washed with a washing solution.

Examples of the washing solution are, but not limited to, the same solvents as those explained to dissolve the polymerization catalyst 38. Among them, highly volatile solvents are suitably used.

Additionally, after the washing using the washing solution, the base material 2 having the graft polymerization layer 3 may be dried.

Through the process above, the graft polymerization layer 3 is formed in the layer formation region 21a on the base material 2 with the polymerization initiation layer 21 interposed therebetween.

Second Formation Method

The second method for forming the graft polymerization layer will now be explained.

Although the second method for forming the graft polymerization layer will be explained below, mainly the differences from the first formation method will be explained, and descriptions of similar content will not be repeated.

The second method for forming the graft polymerization layer is similar to the first formation method, except that the first solution is supplied to the layer formation region 21a on the polymerization initiation layer 21 after supplying the second solution.

Specifically, in the second formation method, the first liquid film containing the first monomers 37 is first formed on the polymerization initiation layer 21, and the first solution is then supplied to this first liquid film so as to form the second liquid film containing the first monomers 37 and the polymerization catalyst 38.

Such a structure also produces the same effect as that explained in the first formation method.

Additionally, there is a tendency that, between the first and second solutions, the second solution containing the first monomers 37 generally has the higher viscosity. Therefore, as is the case in this second formation method, by supplying the second solution having the higher viscosity than the first solution to the layer formation region 21a on the polymerization initiation layer 21 before supplying the first solution, the first solution supplied using the droplet discharge method is reliably prevented from spreading out of the region 21a. As a result, the first and second liquid films can be reliably formed in the region 21a. That is, the graft polymerization layer 3 can be more reliably formed in the region 21a.

Third Formation Method

The third method for forming the graft polymerization layer will now be explained.

In the following, although the third method for forming the graft polymerization layer will be explained, mainly the difference from the first formation method will be explained, and descriptions of similar content will not be repeated.

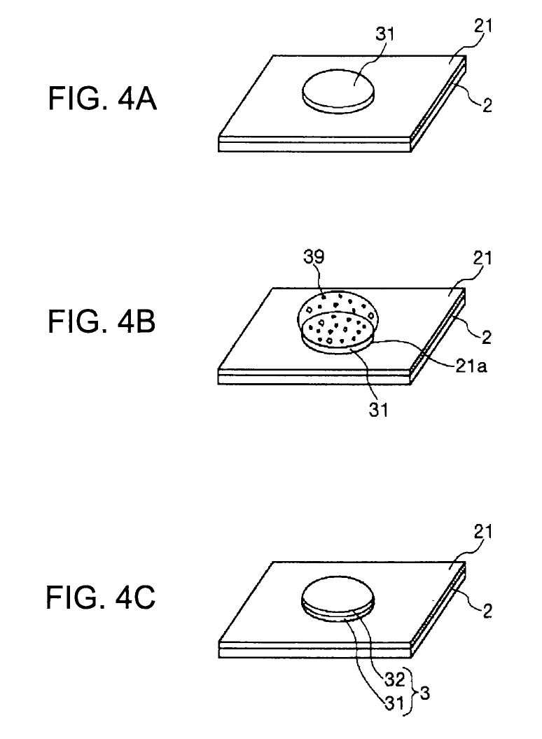

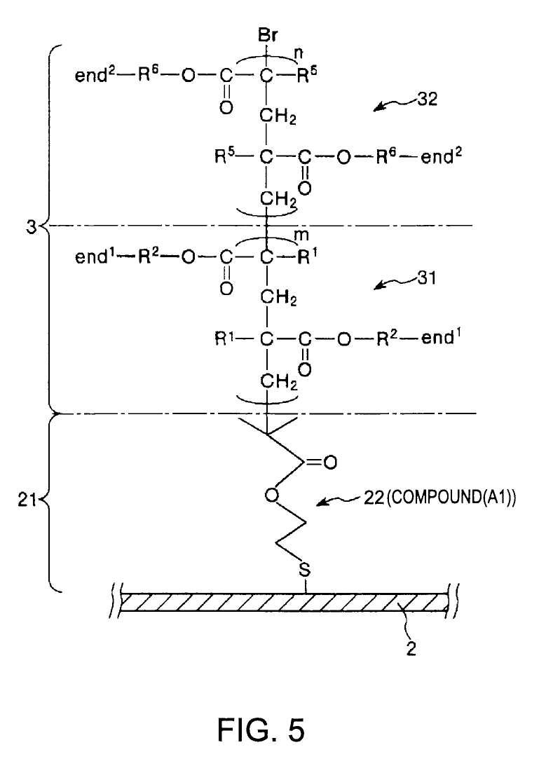

FIG. 4(A) through FIG. 4(C) are schematic diagrams to explain the third method for forming a graft polymerization layer. FIG. 5 is a pattern diagram to explain each process of the method for forming the graft polymerization layer shown in FIG. 4(A) through FIG. 4(C). In the following descriptions, “on” is used to mean upper side and “under” to mean lower side in FIGS. 4(A) to 4(C) and FIG. 5.

The third method for forming the graft polymerization layer is similar to the first formation method except that the graft polymerization layer 3 is obtained by forming a second graft polymer 32 that is linked to the first graft polymer 31.

More specifically, the third formation method is similar to the first formation method except that, by supplying a third solution containing the second monomers 39 (FIG. 4B) onto the first graft polymerization layer 31 that is formed by the first formation method as shown in FIG. 4A, the second graft polymer 32 is formed to be linked to the first graft polymer 31, and the graft polymerization layer 3 composed of the first and second graft polymers 31 and 32 is formed as a result.

Hereafter, each process for forming the second graft polymer 32 will be described in detail.

1B: Washing Process

The aforementioned process 3A is followed by washing of the second liquid film that is remained on the first graft polymerization layer 3 formed in the layer formation region 21a on the polymerization initiation layer 21.

Washing of the second liquid film can be conducted similarly to the previous process 5A.

2B: Process for Supplying Third Solution (Third Process)

Prepared next is the third solution containing the second monomer 39 having a polymerizable group polymerizable to the first graft polymer 31 that is the first monomer and a second side chain different from the first side chain. The third solution is fixed, for example, by dissolving the second monomers 39 in a solvent.

The polymerizable group contained in the second monomer 39 preferably includes a styryl group or a (meta)acryloyl group for the same reason as in the case with the first monomer 37.

Examples of the second monomer 39 are compounds expressed by the following chemical formulae D and E.

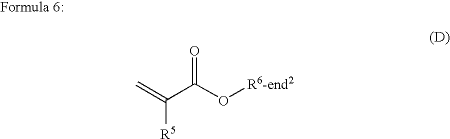

(where end² represents a terminal group of the second side chain; R⁵ represents a hydrogen atom, a methyl group, or an ethyl group; R⁶ represents a single bond, a methylene group, or an ethylene group.)

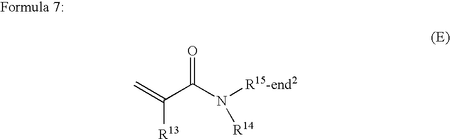

(where end² represents a terminal group of the second side chain; R¹³, R¹⁴ represents an hydrogen atom, a methyl group, or an ethyl group; R¹⁵ represents a single bond, a methylene group, or an ethylene group.)

Examples of the terminal group (end²) of the second side chain may be the same as the examples of the terminal group (end¹) of the first side chain. However, in the third formation method, a terminal group to be selected as the terminal group of the second side chain is different from that used as the terminal group of the first chain.

The solvent to dissolve the second monomers 39 may be, but not limited to, the same solvent as that explained to dissolve the polymerization catalyst 38, for example.

In the embodiments of the invention, the polymerization catalyst 38 is also not contained in the third solution as it is not contained in the second solution. Therefore, it is possible to reliably prevent the second monomers 39 from linking to each other, that is, to prevent generation of dimers, oligomers, polymers, and the like in the third solution.

A third liquid film containing the second monomers 39 is now formed by supplying the third solution using the droplet discharge method to the layer formation region 21a of the polymerization initiation layer 21 on which the first graft polymerization layer 3 has been formed.

Note that, at the terminal of the first graft polymer 31, the chemical bond activated by the polymerization catalyst 38 is remained as a growing terminal. Therefore, if the second monomer 39 contained in the third liquid film comes in contact with this growing terminal, the second monomer 39 links to the growing terminal while regenerating the growing terminal, and the main chain composed of the second monomer 39 is thereby elongated. Consequently, the second graft polymer 32 having the plurality of second monomers 39 linked to the terminal of the first graft polymer 31 is synthesized. As a result, the graft polymerization layer 3 constituted of the first and second graft polymers 31, 32 is formed.

If, for example, the compound expressed by the formula D is used as the second monomer 39, the second graft polymer 32 that is linked to the first graft polymer 31 having the growing terminal as shown in FIG. 5 is formed.

As described, the second solution (first monomers 37) and the third solution (second monomers 39) are sequentially supplied using the droplet discharge method to the layer formation region 21a on the polymerization initiation layer 21, thereby forming the graft polymerization layer 3 containing a graft polymer having a complex structure in which the second graft polymer 32 is linked to the first graft polymer 31.

FIG. 5 shows a case in which the first and second graft polymers 31, 32 are linked to one polymerization initiator 22 that is linked to the base material 2. However, in reality, there are a plurality of polymerization initiators 22 linked to the base material 2, and the first and second graft polymer 31, 32 are linked to each of the initiators 22.

3B: Process for Supplying Polymerization Terminating Solution

Polymerization of the second monomers 39 with the second graft polymer 32 will now be terminated. This process may be conducted in a similar manner as described in the process 4A, for example.

4B: Washing Process

The third liquid film remained on the graft polymerization layer 3 will now be washed. The washing is conducted in a similar manner as described in the process 5A using the washing solution.

Through this process, the graft polymerization layer 3 is formed in the layer formation region 21a on the base material 2 with the polymerization initiation layer 21 interposed therebetween.

In the third formation method, also, the same effect as described in the first formation method can be produced.

In addition, in the third formation method, the washing process as shown in the process 1B may be omitted. In such a case, the third liquid film is formed in coexistence with the first and second monomers 37, 39. Thus, the second graft polymer 32, also, is formed in coexistence with the first and second monomers 37, 39 as the monomer components composing the polymer.

Fourth Formation Method

The fourth method for forming the graft polymerization layer will now be explained.

Although the fourth method for forming the graft polymerization layer will be explained below, mainly the difference from the first formation method will be explained, and descriptions of similar content will not be repeated.

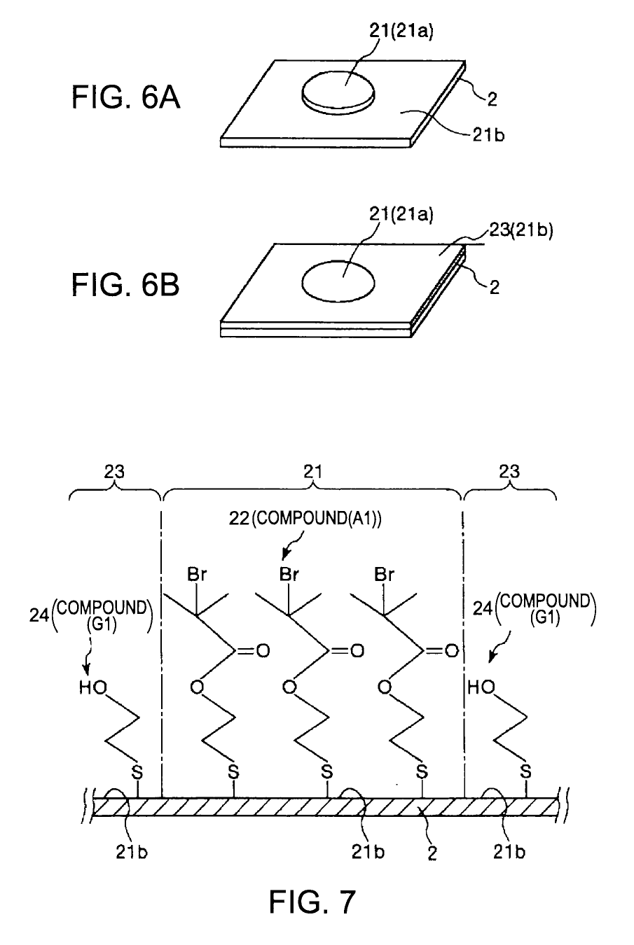

FIGS. 6A and 6B are schematic diagrams to explain the fourth method for forming the graft polymerization layer. FIG. 7 is a pattern diagram to explain each process of the method for forming the graft polymerization layer shown in FIGS. 6A and 6B. In the following descriptions, “on” is used to mean upper side and “under” to mean lower side in FIGS. 6A, 6B, and 7.

In the fourth method for forming the graft polymerization layer, with reference to FIG. 6A, the polymerization initiation layer 21 is formed in the layer formation region 21a corresponding to the site on the base material 2 where the graft polymerization layer 3 is to be formed. The fourth formation method is the same as the first formation method, except that, with reference to FIG. 6B, a stabilizing layer 23 is formed in a non-layer-formation region 21b on the base material 2 where the polymerization initiation layer 21 is not formed. That is, the fourth method for forming the graft polymerization layer is the same as the first formation method except that the polymerization initiation layer 21 is formed so as to correspond to the layer formation region 21a, and that the stabilizing layer 23 is formed so as to correspond to the non-layer-formation region 21b.

Hereunder, each process for forming the polymerization initiation layer 21 and the stabilizing layer 23 will be described in detail.

IC: Process for Forming Polymerization Initiation Layer

First, in a similar manner as in the process 1A, the compound A1 as the polymerization initiator 22 is prepared, and the solution containing this polymerization initiator 22 is fixed.

Then, this solution containing the polymerization initiator 22 is supplied using the droplet discharge method onto the layer formation region 21a on the base material 2. An SH group of this polymerization initiator 22 is thereby reacted with the surface of the base material 2, and the polymerization initiation layer 21 is bonded (linked) to the layer formation region 21a of the base material 2 by —S— bond with reference to FIG. 7. As a result, the polymerization initiation layer 21 is selectively formed in the layer formation region 21a of the base material 2.

To selectively form the polymerization initiation layer 21 on the layer formation region 21a of the base material 2, a photolithography method mentioned below may be used instead of the droplet discharge method.

As in the process 1A, the polymerization initiation layer 21 is first formed over the entire upper surface of the base material 2. Then, using the photolithography method, a resist layer is formed over the polymerization initiation layer 21 that exists in the film formation region 21a. Then, using this resist layer as mask, the polymerization initiation layer 21 that exists in the non-film-formation region 21b outside the film formation region 21a is removed by various etching methods so as to selectively form the polymerization initiation layer 21 in the layer formation region 21a of the base material 2.

2C: Process for Forming Stabilizing Layer

Prepared as a stabilizing agent 24 is a compound G1 below which has a terminal group at one end that is not activated by the polymerization catalyst 38 and an SH group at the other end that acts as a linking group. A solution containing this stabilizing agent 24 is then fixed.

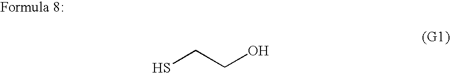

The solution containing this stabilizing agent 24 is then supplied by the droplet discharge method to the non-layer-formation region 21b on the base material 2 outside the film formation region 21a, that is, to the region where the polymerization initiation layer 21 is not formed. This brings an SH group of the stabilizing agent 24 into reaction with the surface of the base material 2, thereby bonding (linking) the stabilizing agent 24 to the surface of the base material 2 by —S— bond as illustrated in FIG. 7. As a consequence, the stabilizing layer 23 is selectively formed in the non-layer formation region 21b of the base material 2.

As an example of the stabilizing agent 24, a compound G2 below having a Si—X group as a linking group may be used instead of the compound G1.

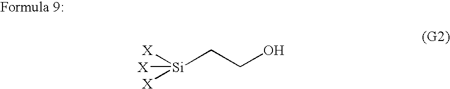

(where X represents a hydrolysable group that produces a silanol group by hydrolysis.)

Instead of the hydroxyl group contained in the compounds G1 and G2, the terminal group not activated by the polymerization catalyst 38 may be, for example, a carboxyl group, an alkyl group, or a fluorine molecule. Because such a terminal group is not activated by the polymerization catalyst 38 unlike the chemical bond that is activated by the polymerization catalyst 38, it is possible to reliably prevent the first monomer 37 from linking (bonding) to this terminal group even if the first monomer 37 comes in contact with the terminal group.

Through the processes above, the polymerization initiation layer 21 and the stabilizing layer 23 are formed in the layer formation region 21a and the non-layer-formation region 21b, respectively, of the base material 2.

As described, by selectively form the polymerization initiation layer 21 in the layer formation region 21a of the base material 2, the following effect is produced. That is, when forming the graft polymerization layer 3, even if the first monomers 37 and the polymerization catalyst 38 are supplied to the non-layer-formation region 21b, it is possible to reliably prevent formation of the graft polymerization layer 3 at the non-layer-formation region 21b because the polymerization initiation layer 21 is not formed in this region 21b. In other words, it is possible to improve the precision in forming the graft polymerization layer 3 corresponding to the layer formation region 21a.

Although the process 2C may be omitted if needed, various functions are given to the stabilizing layer 23 by suitably setting the kinds of the terminal group. For example, if an alkyl group or a fluorine molecule is used as the terminal group, the stabilizing layer 23 attains liquid repellency. Therefore, the first and second liquid films formed on the polymerization initiation layer 21 may be reliably prevented from spreading.

Electronic Device

Described next is an electronic device containing the graft polymerization layer formed by the described method for forming the graft polymerization layer of the embodiments of the invention.

The graft polymerization layer may be applied to various kinds of layers contained in an electronic device, by suitably establishing the kind of terminal group of each side chain contained in the graft polymerization layer and the kinds of substituent group and modifying group to be introduced to each side chain.

For example, if the graft polymerization layer is such that a substituent group or a modifying group is introduced to each side chain as mentioned above, this graft polymerization layer can be applied to a reactive layer included in various types of sensors. Further, if a carrier transport material is introduced to each side chain as a substituent group, it is possible to apply such a graft polymerization layer to a hole transport layer or an electron transport layer contained in an organic electroluminescence element (organic EL element). Furthermore, by suitably establishing the kind of terminal group of each side chain, the produced graft polymerization layer can be applied to various kinds of layers included in an organic thin film transistor (organic TFT).

Described below is one example in which the graft polymerization layer formed by the method for forming the graft polymerization layer of the embodiments of the invention is applied to various kinds of layers included in the organic thin film transistor.

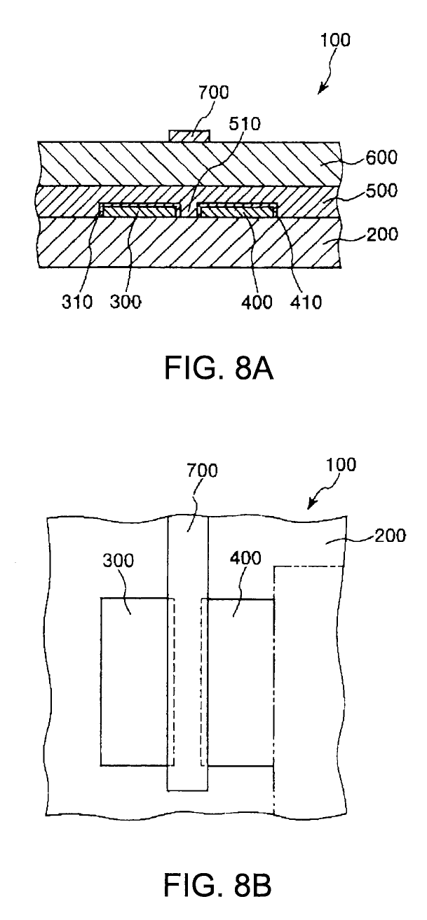

FIGS. 8A and 8B show the organic thin film transistor having the top gate structure. FIG. 8A shows the longitudinal sectional view, and FIG. 8B shows the plan view of the transistor. In the following descriptions, “on” is used to mean upper side and “under” to mean lower side in FIGS. 8A and 8B.

With reference to FIGS. 8A and 8B, a thin film transistor 100 is provided on a substrate 200 and composed of source and drain electrodes 300, 400, intermediate layers 310 and 410, an organic semiconductor layer (organic layer) 500, a gate insulating layer 600, and a gate electrode 700 that are stacked in this order from the side adjacent to the substrate 200.

Specifically, the thin film transistor 100 is provided on the substrate 200 and includes the source electrode 300 and the drain electrode 400 that are located separately. The intermediate layers 310, 410 are provided covering the electrodes 300, 400, and the organic semiconductor layer 500 is provided covering the intermediate layers 310, 410. Provided on this organic semiconductor layer 500 is the gate insulating layer 600. The gate electrode 700 is provided on this gate insulating layer 600 while overlapping at least a region between the source electrode 300 and the drain electrode 400.

In this thin film transistor 100, the region between the source electrode 300 (intermediate layer 310) and the drain electrode 400 (intermediate layer 410) is a channel region 510 through which carriers transfer.

Such a thin film transistor 100 is the thin film transistor having the top gate structure in which the source electrode 300 and the drain electrode 400 are provided closer to the side adjacent to the substrate 200 than to the gate electrode 700, with the gate insulating layer placed therebetween.

Hereafter, each part constituting the thin film transistor 100 will be explained in order.

The substrate 200 supports each of the layers (parts) constituting the thin film transistor 100. The material for the substrate is, for example, a glass substrate, a plastic substrate (resin substrate) composed of, e.g., polyimide, polyethylene terephthalate (PET), polyethylene naphthalate (PEN), polyethersulfon (PES), or aromatic polyester (liquid crystal polymer), a quartz substrate, a silicon substrate, or a gallium arsenide substrate.

On the substrate 200, the source electrode 300 and the drain electrode 400 are provided in parallel in the channel length direction with a predetermined gap therebetween.

The constituent material suitably used for each of the source and drain electrodes 300, 400 is, but not limited to, Ni, Cu, Co, Au, Pd, or an alloy containing these metals.

Further, the intermediate layers 310, 410 are provided covering the source and drain electrodes 300, 400.

The graft polymerization layer formed by the method for forming the graft polymerization layer according to the embodiments of the invention may be applied to these intermediate layers 310, 410.

More specifically, if the source and drain electrodes 300, 400 are composed of Au or an alloy containing Au, and if the intermediate layers 310, 410 are formed using the described first formation method, the polymerization initiation layer 21 is formed using the compound A1, and the graft polymerization layer 3 is formed using the first monomer 37 as the terminal group of the first side chain having good affinity to the organic semiconductor layer 500. As a consequence, the intermediate layers 310, 410 have great adherence to both the source and drain electrodes 300, 400 and the organic semiconductor layer 500. As a result, it becomes possible to smoothly deliver carriers between the source and drain electrodes 300, 400 and the organic semiconductor layer 500, with the intermediate layers 310, 410 interposed therebetween.

Further, on the substrate 200, the organic semiconductor 500 is provided covering the intermediate layers 310, 410.

The organic semiconductor layer 500 is mainly constituted of an organic semiconductor material (organic material that shows semiconductive electric conductivity).

Examples of the organic semiconductor material are, but not limited to: a low-molecular organic semiconductor material such as naphthalene, anthracene, tetracene, or derivatives thereof, and a macromolecular organic semiconductor material (conjugated macromolecular material) such as fluorine-bithiophene copolymer, fluorine-arylamine copolymer, or derivatives thereof. These kinds may be used singly, or more than one of these kinds may be used in combination.

On the organic semiconductor layer, the gate insulating layer 600 is provided.

The gate insulating layer 600 insulates the gate electrode 700 against the source and drain electrodes 300, 400.

The graft polymerization layer formed by the method for forming the graft polymerization layer of the embodiments of the invention may be applied to this gate insulating layer 600.

Specifically, if the gate insulating layer 600 is formed using the first method described hereinbefore, the polymerization initiation layer 21 is formed using the compound A2, and the graft polymerization layer 3 is formed using the first monomer 37 having good insulation property as the terminal group of the first side chain. Accordingly, the gate insulating layer 600 functions as an insulating film and has good adherence to the organic semiconductor layer 500.

On the gate insulating layer 600, the gate electrode 70 is provided.

Examples of the constituent material of the gate electrode 700 are, but not limited to, a metal material such as Pd, Pt, Au, and an alloy containing these metals and an electrically conductive oxide such as indium tin oxide (ITO) or fluorine doped tin oxide (FTO).

Additionally, the graft polymerization layer formed by the method for forming the graft polymerization layer of the embodiments of the invention may also be applied when integrally forming the organic semiconductor layer 500 and the gate insulating layer 600.

Specifically, when providing the organic semiconductor layer 500 and the gate insulating layer 600 using the third formation method as described hereinbefore, the polymerization initiation layer 21 is formed using the compound A2, and the graft polymerization layer 3 is formed using the first monomer 37 having a good carrier transport property as the terminal group of the first side chain and the second monomer 39 having a good insulation property as the terminal group of the second side chain. As a result, the organic semiconductor layer 500 and the gate insulating layer 600 are integrally formed in this order as a laminate.

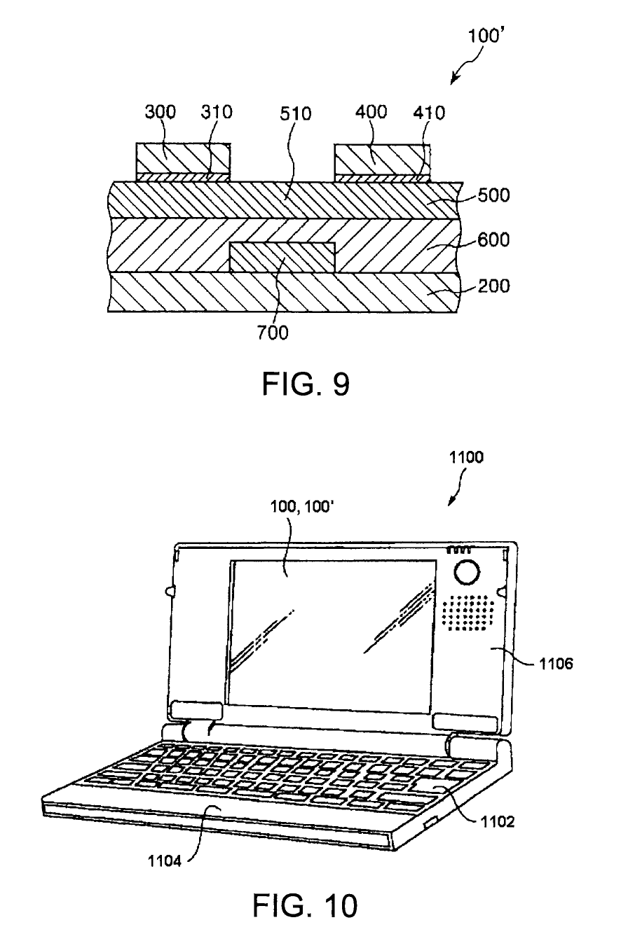

FIG. 9 is a vertical sectional diagram showing an organic thin film transistor having a bottom gate structure. In the following descriptions, “on” is used to mean upper side and “under” to mean lower side in FIG. 9.

The organic thin film transistor of FIG. 9 will be described below focusing on differences from the thin film transistor of FIG. 8, and explanations of similar content will not be repeated.

With reference to FIG. 9, a thin film transistor 100′ is provided on the substrate 200 and is composed of the gate electrode 700, the gate insulating layer 600, the organic semiconductor layer (organic layer) 500, intermediate layers 310 and 410, the source and drain electrodes 300, 400 that are stacked in this order from the side adjacent to the substrate 200.

Specifically, in the thin film transistor 100′, the gate electrode 700 is provided on the substrate 200 while overlapping at least a region between the source electrode 300 and the drain electrode 400. The gate insulating layer 600 is provided covering the gate electrode 700, and the organic semiconductor layer 500 is provided on the gate insulating layer 600. Further, the intermediate layers 310, 410 are separately provided on the gate insulating layer 600, and the source and drain electrodes 300, 400 are provided on top of these layers.

Such a thin film transistor 100′ is the thin film transistor having the bottom gate structure in which the gate electrode 700 is provided closer to the side adjacent to the substrate 200 than to the source and drain electrodes 300, 400, with the gate insulating layer 600 interposed therebetween.

In such a thin film transistor 100′, the graft polymerization layer formed by the method for forming the graft polymerization layer according to the embodiments of the invention can be applied to the intermediate layers 310, 410, and the gate insulating layer 600.

Specifically, when forming the intermediate layers 310, 410 using the first formation method described hereinbefore, the polymerization initiation layer 21 is formed using the compound A2, and the graft polymerization layer 3 is formed using the first monomer 37 having good affinity to the source and drain electrodes 300, 400 as the terminal group of the first side chain. Accordingly, the intermediate layers 310, 410 attain good adherence to both the organic semiconductor layer 500 and the source and drain electrodes 300, 400. As a result, it becomes possible to smoothly deliver carriers between the source and drain electrodes 300, 400 and the organic semiconductor layer 500, with the intermediate layers 310, 410 therebetween.

Also, when forming the gate insulating layer 600 using the first formation method described hereinbefore, the polymerization initiation layer 21 is formed using the compound A2, and the graft polymerization layer 3 is formed using the first monomer 37 having a good insulation property as the terminal group of the first side chain. Accordingly, the gate insulating layer 600 functions as an insulating film and has good adherence to the substrate 200.

Additionally, when integrally forming the gate insulating layer 600 and the organic semiconductor layer 500, the graft polymerization layer formed by the method for forming the graft polymerization layer according to the embodiments of the invention may be applied.

Specifically, when forming the gate insulating layer 600 and the organic semiconductor layer 500 using the third formation method described hereinbefore, the polymerization initiation layer 21 is formed using the compound A2, and the graft polymerization layer 3 is formed using the first monomer 37 having a good insulation property as the terminal group of the first side chain and the second monomer 39 having a good carrier transport property as the terminal group of the second side chain. As a result, the gate insulating layer 600 and the organic semiconductor layer 500 are integrally formed in this order as a laminate.

With the thin film transistors 100, 100′ as described, the amount of current flowing between the source electrode 300 and the drain electrode 400 is controlled by varying a voltage applied to the gate electrode 700.

Specifically, in an OFF state where no voltage is applied to the gate electrode 700, a very little current flows even if a voltage is applied between the source and drain electrodes 300, 400 because hardly any carriers exist in the organic semiconductor layer 500. In contrast, in an ON state where a voltage is applied to the gate electrode 700, an electric charge is induced at a portion of the organic semiconductor layer 500 facing the gate insulating layer 600, thereby forming a carrier flow path in the channel region 510. If a voltage is applied between the source and drain electrodes 300, 400 in this state, a current flows through the channel region 510.

Electronic Apparatus

The electronic device of the invention such as the above-described organic TFT (switching element) may be used in various types of electronic apparatuses.

FIG. 10 is a perspective diagram showing the composition of a mobile-type (or notebook-type) personal computer using the electronic device of the invention.

In this illustration, a personal computer 1100 is composed of a main body 1104 having a keyboard 1102 and a display unit 1106 having a display section. The display unit 1106 is rotatably supported against the main body 1104 with a hinge structure therebetween.

In this personal computer 1100, the display unit 1106 includes, for example, the organic TFT (switching element) as described above.

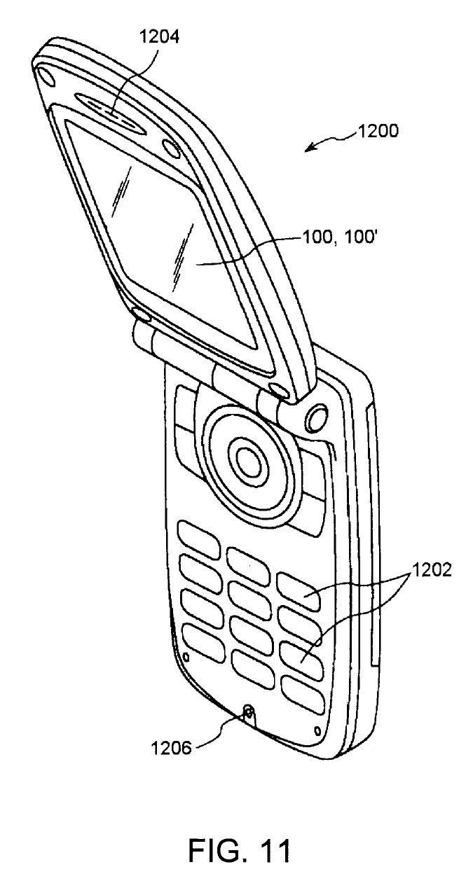

FIG. 11 is a perspective diagram showing the composition of a mobile phone (including PHS) using the electronic device of the invention.

In this illustration, a mobile phone 1200 is equipped with a plurality of operation buttons 1202, a receiving port 1204, a transporting port 1206, and a display section.

In the mobile phone 1200, the display section, for example, contains the organic TFT (switching element) 100 as described above.

In addition to the personal computer (mobile personal computer) of FIG. 10 and the mobile phone of FIG. 11, the electronic device of the invention may also be applied to: TVs, digital still cameras, video cameras, view-finder-type and direct-monitor-type videotape recorders, laptop type personal computers, car navigation systems, pagers, electronic organizers (including those with communication functions), electronic dictionaries, desktop electronic calculators, electronic videogame instruments, word processors, workstations, TV phones, security TV monitors, electronic binoculars, point-of-sale (POS) terminals, instruments with touch panels (e.g., automatic teller machines of financial institutions and automatic ticket vending machines), medical instruments (e.g., electronic thermometers, blood pressure monitors, blood glucose monitors, electrocardiographic monitors, untrasonic diagnostic equipment, and endoscopic display systems), fish detectors, various measuring instruments, gauges (in, e.g., automobiles, airplanes, and ships), flight simulators, other various monitors, or projection type displays such as projectors.

Described hereinabove are the method for forming the graft polymerization layer, the electronic device, and the electronic apparatus of the invention based on the illustrated embodiments. However, the invention is not limited to these embodiments.

For example, the method for forming the graft polymerization layer according to the embodiments of the invention may include one or more additional processes for any given purposes.

Also, in the method for forming the graft polymerization layer according to the embodiments of the invention, any one or more structures (features) of the formation methods described above may be combined in order to form the graft polymerization layer.

What is claimed is:

1. A method for forming a graft polymerization layer, comprising:
(a) forming a polymerization initiation layer on a base material by linking the base material with a linking group of a polymerization initiator that contains the linking group and a chemical bond activated by a polymerization catalyst; and
(b) separately supplying to at least a partial region on the polymerization initiation layer a first solution containing the polymerization catalyst and a second solution containing a first monomer having a group polymerizable to the chemical bond and a first side chain by use of a droplet discharge method so as to form the graft polymerization layer constituted of a first graft polymer containing more than one first monomer linearly linked to the chemical bond.

2. A method for forming a graft polymerization layer, comprising:
(a) forming a polymerization initiation layer on a base material by linking the base material with a linking group of a polymerization initiator that contains the linking group and a chemical bond activated by a polymerization catalyst, and forming a stabilizing layer containing a stabilizing agent having no chemical bond activated by the polymerization catalyst but having the linking group that links the stabilizing agent to the base material in a region on the base material outside the region for forming the polymerization initiation layer; and
(b) separately supplying to at least a partial region on the polymerization initiation layer a first solution containing the polymerization catalyst and a second solution containing a first monomer having a group polymerizable to the chemical bond and a first side chain by use of a droplet discharge method so as to form the graft polymerization layer constituted of a first graft polymer containing more than one first monomer linearly linked to the chemical bond.

3. The method for forming a graft polymerization layer according to claim 1, wherein, in step (a), the polymerization initiation layer is formed corresponding to a site at which the graft polymerization layer is to be formed.

4. The method for forming a graft polymerization layer according to claim 1, wherein, in step (b), the second solution is supplied onto the polymerization initiation layer after supplying the first solution.

5. The method for forming a graft polymerization layer according to claim 1, wherein, in step (b), the first solution is supplied onto the polymerization initiation layer after supplying the second solution.

6. The method for forming a graft polymerization layer according to claim 1, wherein at least a same kind of solvent is used in the first and second solutions.

7. The method for forming a graft polymerization layer according to claim 6, wherein the solvent is ionic liquid.

8. The method for forming a graft polymerization layer according to claim 1, further comprising:
(c) supplying to the layer formation region a third solution containing a second monomer having the group polymerizable to the first monomer and a second side chain different from the first side chain so as to link a second graft polymer containing more than one second monomers linearly linked to the first graft polymer.

9. The method for forming a graft polymerization layer according to claim 8, further comprising washing the first and second solutions prior to step (c).

10. The method for forming a graft polymerization layer according to claim 1, further comprising introducing a substituent group to the first side chain after step (b).

11. The method for forming a graft polymerization layer according to claim 1, further comprising introducing a modifying group to a terminal of the first graft polymer after step (b).

12. An electronic device containing the graft polymerization layer formed by the method for forming a graft polymerization layer according to claim 1.

13. An electronic apparatus containing the electronic device according to claim 12.
